(19) United States
(12) Patent Application Publication
(10) Pub. No.: US 2021/0399768 A1
(43) Pub. Date: Dec. 23, 2021

(54) INTERCONNECT IN MULTIPLE-INPUT MULTIPLE-OUTPUT COMMUNICATION SYSTEM

(71) Applicant: TELEFONAKTIEBOLAGET LM ERICSSON (PUBL), Stockholm (SE)

(72) Inventors: Martin HESSLER, LINKÖPING (SE); Jan HEDEREN, LINGHEM (SE); Pål FRENGER, Linköping (SE)

(21) Appl. No.: 17/297,676

(22) PCT Filed: Mar. 3, 2020
(86) PCT No.: PCT/SE2020/050235

§ 371 Date: May 27, 2021

Related U.S. Application Data
(60) Provisional application No. 62/823,675, filed on Mar. 26, 2019.

(51) Int. Cl. H04B 7/024; H04B 7/0413

(52) U.S. Cl. CPC H04B 7/024; H04W 92/16; H04B 7/0413

(57) ABSTRACT

A distributed Multiple-Input Multiple-Output system comprises one or more antenna units. Each antenna unit comprises at least one antenna element and at least one Antenna Processing Unit (APU) connected to the antenna element. The APU in the one or more antenna units is configurable such that at least one APU in the one or more antenna units is assigned to service as over-the-air interconnects based on load situation and processing power resource of the APU.

### TECHNICAL FIELD

Embodiments herein relate to Multiple-Input Multiple-Output (MIMO) communication systems. In particular, they relate to MIMO antenna systems comprising multiple antenna units and base stations comprising the MIMO antenna systems in a wireless communication network.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio access node such as a radio access node, e.g. a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as New generation (NG) and 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Massive MIMO is also known as large-scale antenna systems and very large MIMO. Massive MIMO is a multi-user MIMO technology where each base station (BS) is equipped with a large number of antenna elements, typically more than 50, which are being used to serve many terminals that share the same time and frequency band and are separated in the spatial domain. A key assumption is that there are many more BS antennas than terminals; at least twice as many, but ideally as many as possible. Massive MIMO offers many benefits over conventional multi-user MIMO. First, conventional multi-user MIMO is not a scalable technology, since it has been designed to support systems with roughly equal numbers of service antennas and terminals, and practical implementations typically relies on frequency-division duplex (FDD) operation. By contrast, in massive MIMO, the large excess of service antennas over active terminals time-division duplexing (TDD) operation brings large improvements in throughput and radiated energy efficiency. These benefits result from the strong spatial multiplexing achieved by appropriately shaping the signals sent out and received by the base station antennas. By applying precoding to all antennas, the base station can ensure constructive interference among signals at the locations of the intended terminals, and destructive almost everywhere else. Furthermore, as the number of antennas increases, the energy can be focused with extreme precision into small regions in space. Other benefits of massive MIMO include use of simple low-power components since it relies on simple signal processing techniques, reduced latency, and robustness against intentional jamming.

When operating in TDD mode, massive MIMO may exploit the channel reciprocity property, according to which the channel responses are the same in both uplink (UL) and downlink (DL). Channel reciprocity allows the BSs to acquire channel state information (CSI) from pilot sequences transmitted by the terminals in the uplink, and this CSI is then useful for both the uplink and the downlink. By the law of large numbers, the effective scalar channel gain seen by each terminal is close to a deterministic constant. This is called channel hardening. Thanks to the channel hardening, the user devices can reliably decode the downlink data using only long-term statistical CSI, making most of the physical layer control signaling redundant, i.e. low-cost CSI acquisition. This renders the conventional resource allocation concepts unnecessary, and results in a simplification of the Media Access Control (MAC) layer. These benefits explain why massive MIMO has a central position in preliminary 5G discussions.

However, massive MIMO system performances are affected by some limiting factors: Channel reciprocity requires hardware calibration. In addition, the so-called pilot contamination effect is a basic phenomenon which profoundly limits the performance of massive MIMO systems. Theoretically, every terminal in a massive MIMO system could be assigned an orthogonal uplink pilot sequence. However, the maximum number of orthogonal pilot sequences that can exist is upper-bounded by the size of the coherence interval, which is the product of the coherence time and coherence bandwidth. Hence, adopting orthogonal pilots leads to inefficient resource allocation as the number of the user devices increases or it is not physically possible to perform when the coherence interval is too short. As a consequence, pilots must be reused across cells, or even within the home cell for higher cell density. This inevitably causes interference among user devices which share the same pilot. Pilot contamination does not vanish as the number of BS antennas grows large, and so it is the one impairment that remains asymptotically.

To implement massive MIMO in wireless communications networks, two different architectures may be adopted:

Centralized massive MIMO (C-maMIMO), where all the antennas are co-located in a compact area at both the BS and user device sides, as shown in FIG. 1. It represents the conventional massive MIMO system. FIG. 1 depicts a Centralized massive MIMO architecture.

Distributed massive MIMO (D-maMIMO), where BS antennas, herein named as Access Points (APs), are geographically spread out over a large area, in a well-planned or random fashion, as shown in FIG. 2. Antennas are connected together and to a Central Processing Unit (CPU) through high-capacity backhaul links, such as e.g. fiber-optic cables. It is also known as cell-free massive MIMO system. FIG. 2 depicts a Distributed massive MIMO architecture.

D-maMIMO architecture is an important enabler of network MIMO in future standards. Network MIMO is a terminology that is used for a cell-free wireless network, where all the BSs that are deployed over the coverage area act as a single BS with distributed antennas. This may be considered the ideal network infrastructure from a performance perspective, since the network has great abilities to spatially multiplex users and exactly control the interference that is caused to everyone.

The distinction between D-maMIMO and conventional distributed MIMO is the number of antennas involved in coherently serving a given user device. In D-maMIMO, every antenna serves every user device. Compared to C-maMIMO, D-maMIMO has the 10 potential to improve both the network coverage and the energy efficiency, due to increased macro-diversity gain. This comes at the price of higher fronthaul requirements and the need for distributed signal processing. In D-maMIMO, the information regarding payload data, and power control coefficients, is exchanged via the backhaul network between the APs and the CPU. There is no exchange of instantaneous CSI among the APs or the central unit, that is CSI acquisition may be performed locally at each AP.

Due to network topology, D-maMIMO suffers from different degrees of path losses caused by different access distances to different distributed antennas, and very different shadowing phenomena that are not necessarily better, e.g., antennas deployed at the street level are more easily blocked by buildings than antennas deployed at elevated locations. Moreover, since the location of antennas in D-maMIMO has a significant effect on the system performance, optimization of the antenna locations is crucial. In addition, D-maMIMO potentially suffers a low degree of channel hardening. As mentioned earlier, the channel hardening property is key in massive MIMO to suppress small-scale fading and derives from the large number of antennas involved in a coherent transmission. In D-maMIMO, APs are distributed over a wide area, and many APs are very far from a given user device. Therefore, each user device is effectively served by a smaller number of APs. As a result, channel hardening may be less pronounced. This would considerably affect the system performance.

The performance of any wireless communications network is clearly the availability of good enough CSI to facilitate phase-coherent processing at multiple antennas. Intuitively, acquiring high quality CSI should be easier with a C-maMIMO than in a D-maMIMO where the antennas are distributed over a large geographical area. Nevertheless, the macro-diversity gain has a dominant importance and leads to improved coverage and energy efficiency.

A problem with a massive MIMO deployment is that a large number of antennas generate a large amount of data. This implies that with traditional radio to antenna interfaces very large capacity fiber network are needed to shuffle this data around. Fiber is both expensive and needs skilled personnel for installation. Both of which limit the deployment scenarios for massive MIMO. There is also a scalability issue as different size base-band units are needed to handle different array sizes, e.g. one to handle 32 antennas and one other for 128 antennas etc.

From a practical point of view, the C-maMIMO solution where all antenna elements, e.g., APs, are placed close together has a number of drawbacks compared to the D-maMIMO solution where the antenna elements are distributed over a larger area. These are e.g.:

Very large service variations: UEs that happen to be located close to the central massive MIMO node will experience very good service quality while for UEs further away the service quality will degrade rapidly.

Sensitive to blocking: On high frequency bands in particular, the signal is easily blocked by obstacles that obscures the line-of-sight between the UE and the C-maMIMO node. In D-maMIMO a number of antenna elements may be blocked but it requires much larger obstacles to block all antenna elements.

High heat concentration: Due to heat concentration it is difficult to make C-maMIMO nodes very small. In D-ma MIMO each antenna element, and its associated processing, generates only a small amount of heat and this simplifies miniaturization.

Large and visible installations: C-maMIMO installations may become large, especially on lower frequency bands. D-maMIMO installations are actually even larger, but the visual impact may be made almost negligible.

Installation requires personnel with “radio skills”: Installing a complex piece of hardware in a single location requires planning and most probably also proper installation by certified personnel. In a D-maMIMO installation it is less crucial that each and every one of the very many antenna elements is installed in a very good location. It is sufficient that the majority of the elements are installed in good enough locations. The requirements on installation may be significantly relaxed with a D-maMIMO deployment. Relaxed when used herein means planning, location and installation may be easier.

Power limited by regulations, e.g. specific absorption rate (SAR): If the antenna elements are located close together there will be an area close to the installation where electromagnetic wave safety rules apply. This is likely to put limits on the total radiated radio frequency power in many installations. In a D-maMIMO installation a user device may come close to a small number of antenna elements, but it is impossible to be physically close to many elements that are distributed over a large area.

There are many significant benefits with D-maMIMO compared to C-maMIMO. But the cabling and internal communication between antenna elements in a D-maMIMO is prohibiting in state-of-the art solutions. It is not economically feasible to connect a separate cable between each antenna element and a central processing unit (e.g. in a star topology) in a D-maMIMO installation.

### SUMMARY

It is an object of embodiments herein to provide a MIMO antenna system with improved performance in a wireless communication network.

Embodiments herein provide a distributed Multiple-Input Multiple-Output, MIMO, system comprising one or more antenna units. Each antenna unit comprises at least one antenna element and at least one Antenna Processing Unit (APU) connected to the antenna element. The APU in the one or more antenna units is configurable such that at least one APU in the one or more antenna units is assigned to service as over-the-air interconnects based on load situation and power resource of the APU.

The terms “antenna units” may be referred to any one of “radio stripes”, “antenna stripes”, “antenna sticks”, “network stripes” etc.

Embodiments herein provide solutions for over-the-air interconnect between antenna units and/or between an antenna unit and a network node by using available antenna elements on an antenna unit. This enables backhaul connection when it is not available for some antenna units, but also enables a very low latency and high capacity interconnects, especially between array of distributed and serial connected antenna units in a massive MIMO antenna system.

Embodiments herein teach a way to enable radio stripe backhaul/interconnect using APUs with available processing resource. This enables more flexible and efficient deployment of radio stripes. Embodiments herein also enable better Coordinated Multipoint (CoMP) operation for radio-stripes using very low latency over-the-air interconnect between different radio stripes or between radio stripes and other network nodes, especially when a good backhaul connection is not available.

### BRIEF DESCRIPTION OF THE DRAWINGS

Examples of embodiments herein are described in more detail with reference to attached drawings in which:

FIG. 1 illustrates a centralized massive MIMO architecture;

FIG. 2 illustrates a distributed massive MIMO architecture;

FIG. 3 illustrates an example embodiment of a massive MIMO radio stripe system;

FIG. 4 illustrates an example of beamforming processing;

FIG. 5 illustrates operations performed in an APU during downlink transmission;

FIG. 6 illustrates an example of uplink processing performed in an APU;

FIG. 7 illustrates a radio stripe comprising of multiple APUs;

FIG. 8 illustrates a MIMO system with daisy-chains according prior art;

FIG. 9 illustrates a wireless communications network in which embodiments herein may be implemented;

FIG. 10 illustrates an example of a radio stripe using unused antenna elements for backhaul/interconnects according to embodiments herein;

FIG. 11 illustrates an example embodiment where a radio stripe functions as an intermediate step (relay) between two other network nodes;

FIG. 12 illustrates example steps for a multi-stripe reception with stripe to stripe backhaul;

FIG. 13 illustrates an example of routing and load sharing using radio stripe over-the-air communication according to embodiments herein;

FIG. 14 illustrate an example with 4 radio stripes in load-sharing configuration according to embodiments herein; and

FIG. 15 illustrates an example of a base station comprising an antenna system according to embodiments herein.

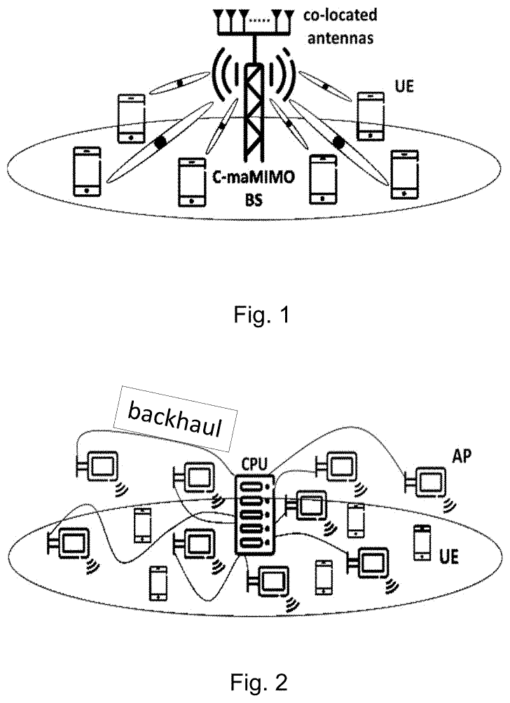

### DETAILED DESCRIPTION

As a part of developing embodiments herein the inventors identified a problem which first will be discussed.

Radio Stripes

Base stations in a radio stripe system may comprise circuit mounted chips inside a protective casing of a cable or a stripe. Receive and transmit processing of each antenna element is performed next to the actual antenna element itself. Since the total number of distributed antenna elements is assumed to be large, e.g. several hundred, the radio frequency transmit power of each antenna element is very low.

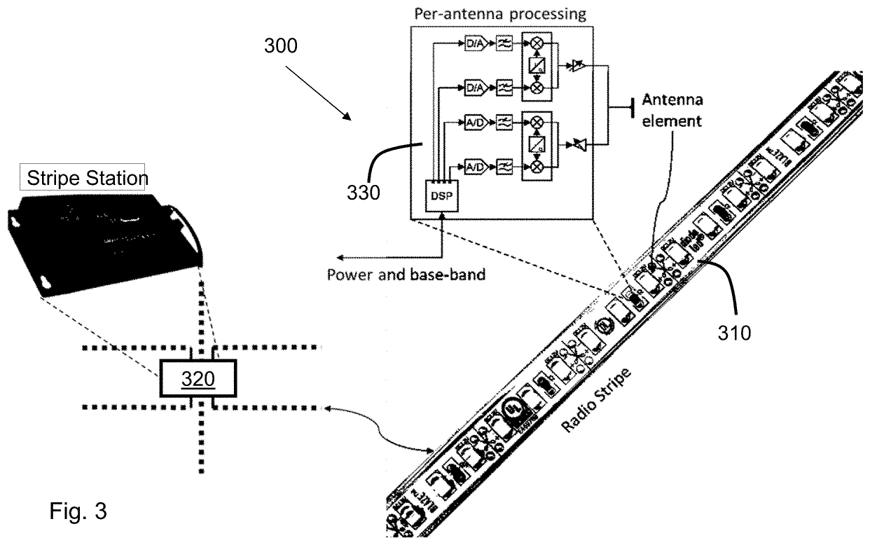

FIG. 3 depicts an example of a massive MIMO radio stripe system 300. The example in FIG. 3 depicts a system mockup and shows a radio stripe 310 connected to a stripe station 320. This figure is only used to exemplify how the actual distributed massive MIMO base station may be envisioned to be built. A central processing unit i.e. the stripe station 320 may) connect with more than one radio stripes or distributed MIMO active antenna cables.

The radio stripe 310 may comprise one or more antenna elements, and next to each antenna element, there may be a per-antenna processing unit 330 for processing receive and transmit data for each antenna element.

The actual radio stripes may comprise tape or adhesive glue on the backside, as in the example of Light Emitting Diode (LED) stripes. Or it may simply contain very small per-antenna processing units and antennas protected by the plastics covering the cable.

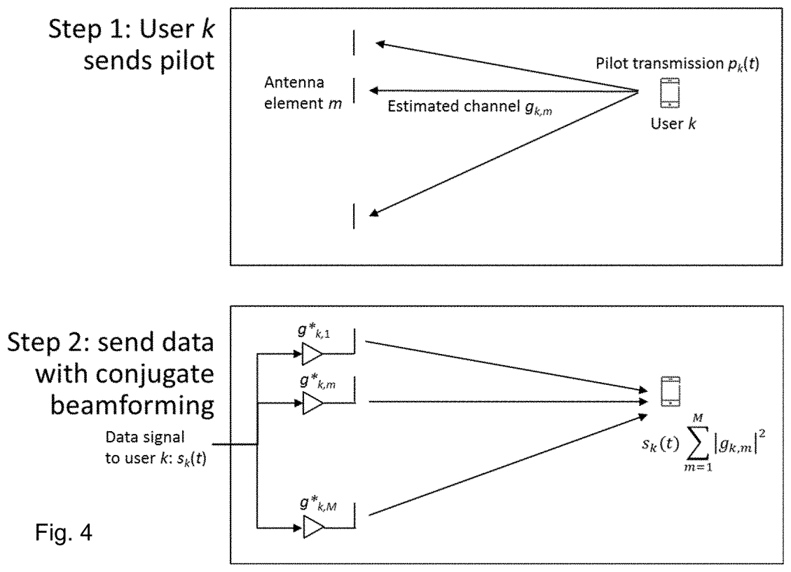

An important observation that has been made is that both the transmitter and receiver processing can be distributed under certain assumptions, e.g. see FIG. 4. FIG. 4 illustrates that by using e.g. conjugate beamforming, the beamforming processing required may be performed per-antenna element. With low-complexity pre-coding methods such as conjugate beamforming, each antenna element may be equipped with a controlling entity, i.e. antenna processing unit (APU) that determines the beamforming weights without communicating with all other APUs. For example, as shown in FIG. 4, in Step 1, user K may send a pilot pₖ(t) to one or more antenna elements m=1, 2 . . . M, with estimated channel power g_{k,m}. In Step 2, each antenna element processes data sₖ(t) to be send to the user K with conjugate beamforming, i.e. by calculating sₖ(t)·g_{k,m}*, where m=1, 2 . . . M. Then the received signal by the user K is calculated by sₖ(t)·Σ|g_{k,m}|².

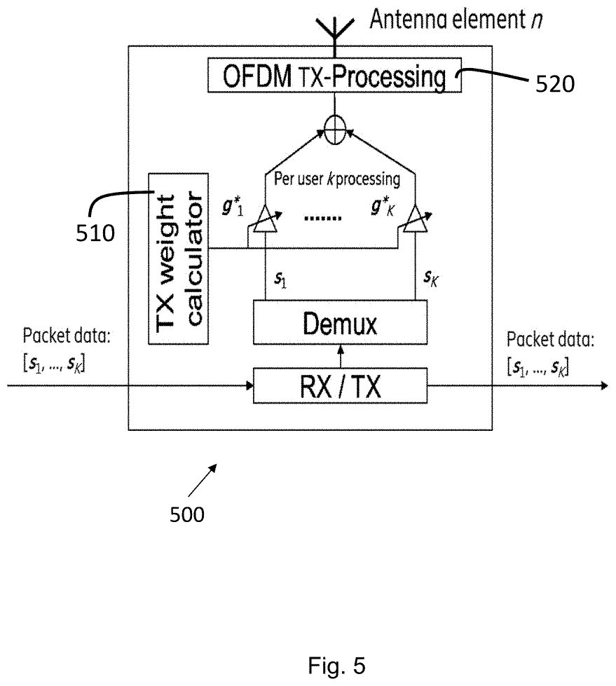

FIG. 5 shows operations performed in an APU 500 during downlink transmission. The APU 500 receives packet data signals Sₖ for each user, k=1, . . . , K. In this example the packet data S₁ . . . Sₖ is a frequency domain vector of Quadrature amplitude modulation (QAM) symbols. The TX antenna weights g₁, . . . gₖ that were determined during the training period in TX weight calculator 510, are applied to the received packet data per user k. The pre-coding coefficients gₖ* are also in the general case a frequency domain vector per user k. After pre-coding the sum-signal is processed by an Inverse Fast Fourier Transform (IFFT) in OFDM TX-Processing 520. Downlink operation and uplink operation are multiplexed by RX/TX 530 and Demux 540.

Note that in case the pre-coding is not frequency selective but instead frequency flat, then the IFFT operation may be performed per user in the CPU instead of distributed in the APUs.

The receiver UL operation in an APU is similar. However, in the UL all signal components received from the different antennas need to be combined. Also, the received signals for each user k are represented by soft-bits of some resolution, e.g. 4 bits per hard-bit. In addition to the received signals per user it may be beneficial to also estimate and communicate an estimate of the channel quality per user.

Fronthaul, also known as antenna fronthaul, is a term that refers to the connection of the Centralized Radio Access Network (C-RAN), a new type of cellular network architecture of centralized baseband units (BBU), at the access layer of the network to remote standalone radio heads at cell sites. With fronthaul, remote radio heads separate the radio elements of a base station from the baseband controller resulting in easier radio deployment e.g. at the top of a cell tower and increased signal coverage range. Disparate radio elements are connected to the centralized controllers through the Common Public Radio Interface (CPRI). The latest CPRI specification adds capacity to remote radio heads, achieves higher-order MIMO and allows multi-carrier configuration. This type of interface supports shared infrastructure and dynamic capacity allocation, which enables the reality of a completely open RAN that can be used for future 5G applications and deployment scenarios.

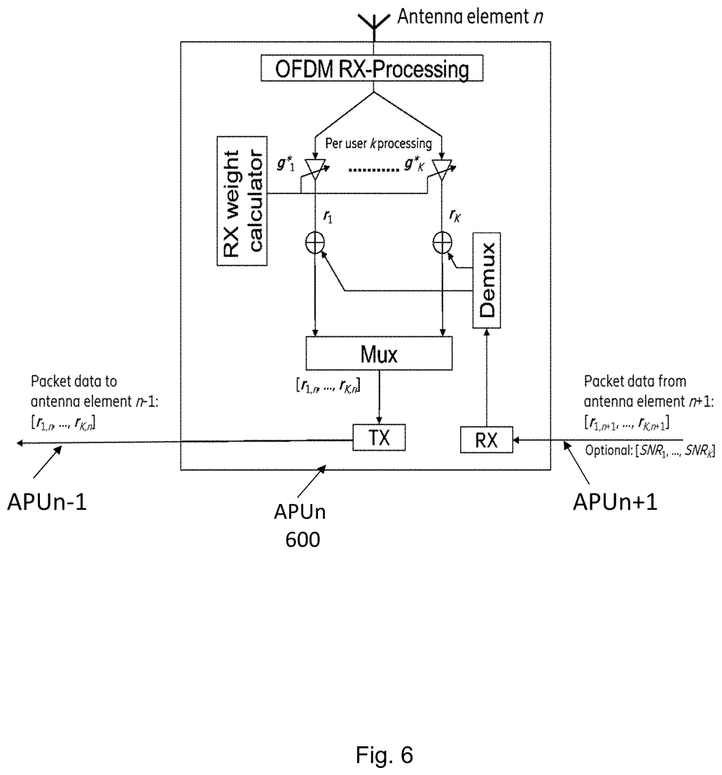

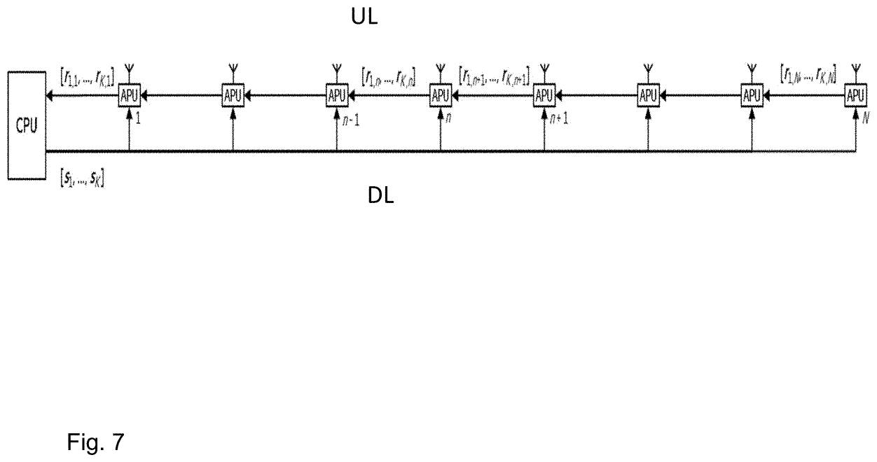

FIG. 6 shows an example of UL processing performed in APUs. Comparing DL in FIG. 5 and UL in FIG. 6, it is noted that in terms of fronthaul communication, the DL is a broadcast channel, i.e. the same signal from CPU to all APUs, while the UL processing has a pipe-line structure, i.e. the nth APU, APUn 600 receives soft information r_{k,n-1} for each user k from the (n+1)th APU, APUn+1; adds its own soft signal components; and forwards the result to the (n−1)th APU, APUn−1. This is depicted in FIG. 7. As shown in FIG. 7, the fronthaul in a radio stripe comprises multiple APUs. The DL has a broad-case structure while the UL has a pipe-line structure.

A prior art solution that utilizes small distributed remote radio heads provides a small and low power remote radio head solution which only comprises Analog-to-Digital (ND), Digital-to-Analog (D/A), and RF up/down converters, power amplifiers and antennas.

If it is tried to implement a distributed (massive) MIMO system using this prior art solution, a separate power-over-Ethernet cable to each radio head would be needed. The radio head is then feed with a Common Public Radio Interface (CPRI) signal and all beamforming logic is performed in a centralized node. This is not a scalable solution since it results in a “spaghetti-monster” of cables if this solution was scaled up to a massive MIMO scale.

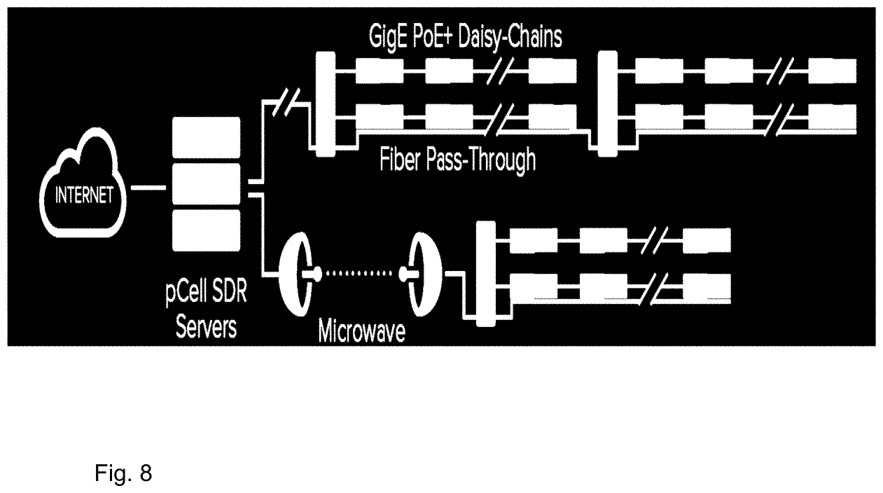

Recently a “daisy-chain” based extension to the above solution that partly addresses this problem, see FIG. 8.

This solution enables one antenna port to be duplicated and distributed over a larger area. But each daisy-chain still only provides one antenna port and it is feed with one CPRI signal that is forwarded to every element in the daisy-chain. The RF-signals transmitted over the air by different nodes are therefore identical in this solution.

To support multiple independent antenna ports that can be used, e.g. for pre-coder-based beamforming they still need parallel daisy chains. This unfortunately results in a spread of interference over an unnecessarily large area. The antenna ports they can use for pre-coder-based beamforming are distributed in space and not point-shaped.

Dynamic TDD

Traditional TDD uses coordination between transmitting/receiving (Tx/Rx) Point (TRP) to determine when there are UL slots and DL slots. This is due to that traditionally DL has much higher power and near/far effects that can give signification interference if the DL/UL slots are aligned in the network.

In dynamic TDD the assignment of DL/UL is dynamic and hence there is not an alignment between UL and DL in the TRPs. This is motivated to work better in 5G compared to older systems. For distributed low power systems, the power level between UL and DL is better aligned. Further for massive-MIMO systems the spatial filtering improves the performance for miss-alignment between UL/DL.

In a distributed massive MIMO system there is no clear boundary between different TRPs. Rather what will determine the relation between different antennas are the physical interconnect, the backhauls and the power distribution. This implies that there is a separation between antennas in different stripes because they are physically connected despite that the stripes may be overlapping in geography, for example, be situated on two sides of the same street. This creates interference, coordination and interconnect problems between different stripes. Especially if different stripes make different decisions on the UL/DL assignments in dynamic TDD.

Another problem is that although stripes are easy to fit into any environment and also quite easy to power, the backhaul can be very hard and expensive which in practice may limit the deployment of antenna stripes.

To solve the problems, embodiments herein divide processing power resources of one or more APUs between access and interconnect or backhaul transmissions in an antenna stripe. In some embodiments, the processing power distribution is to assign all power resources in unused APUs to interconnect or backhaul transmissions. In some embodiments the processing power distribution is to assign all processing power resources to access if a UE is assigned to the APU. According to embodiments herein:

The network may determine a need for interconnect for a radio stripe in a network node.

The radio stripe may assign processing power resources in unused, or low-loaded, or free-able APUs to service as interconnects.

The radio stripe may transmit/receive data on said APUs assigned as interconnects from the network, i.e. not an end-user.

In some embodiments, a network stripe A without backhaul may be connected to a network node B with backhaul using unused APUs in stripe A. In some embodiments the assignment to access-service may be adjusted accordingly.

In some embodiments, a network stripe A and a network node, e.g. a stripe B serving a UE with strong channel to both stripe A and B may be connected using unused APUs for fast Coordinated Multipoint (CoMP).

In some embodiments, a network stripe A with limiting processing resources may be connected to a network node (e.g. a stripe) B with abundant processing resources.

In some embodiments a fraction of the power may be assigned for interconnect on assigned APUs, that is, remaining power may be used for end-user access.

In some embodiments, the interconnect may be used for tight synchronization of the radio-stripe towards a second network node.

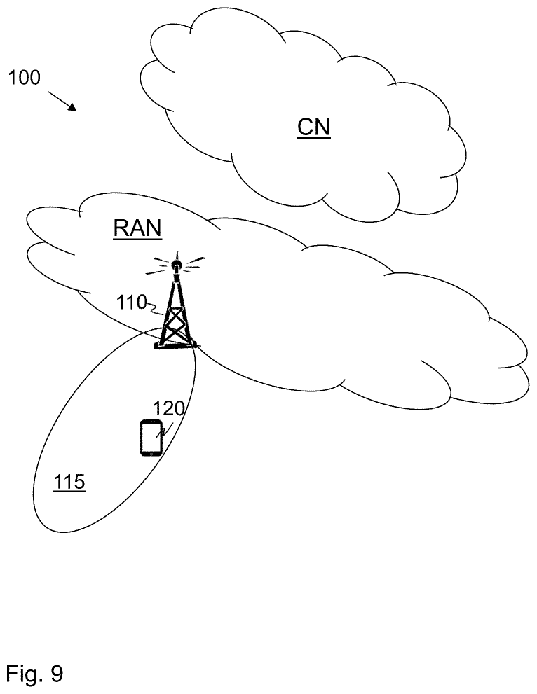

Embodiments herein relate to wireless communication networks in general. FIG. 9 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Base stations such as a base station 110 operate in the wireless communications network 100. The base station 110 provides radio coverage over a geographical area, a service area referred to as a cell 115, which may also be referred to as a beam or a beam group of a first radio access technology (RAT), such as 5G, LTE, Wi-Fi or similar. The base station 110 may each be a NR-RAN node, transmission and reception point e.g. a radio access node such as a Wireless Local Area Network (WLAN) access point or an Access Point Station (AP STA), an access controller, a radio base station such as a NodeB, an evolved Node B (eNB, eNode B), a gNB, a base transceiver station, a remote radio unit, an Access Point Base Station, a base station router, a transmission arrangement of a radio base station, a stand-alone access point or any other network unit capable of communicating with a wireless device within the service area served by the base station 110 depending e.g. on the first radio access technology and terminology used. The base station 110 may be referred to as serving radio access nodes and communicates with a UE with Downlink (DL) transmissions to the UE and Uplink (UL) transmissions from the UE.

A number of UEs operate in the wireless communication network 100, such as the UE 120. The UE 120 may be a mobile station, a non-access point (non-AP) STA, a STA, a user equipment and/or a wireless terminal, that communicates via one or more network nodes such as the base station 110, in a RAN to one or more core networks (CN), e.g. comprising CN node. It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

A distributed or semi-distributed massive MIMO system according to embodiments herein may be implemented in the wireless communication network 100. The MIMO system may comprise one or more radio stripes, antenna stripes, antenna sticks, network stripes. The terms “radio stripes”, “antenna stripes”, “antenna sticks”, “network stripes” are generally referred to as “antenna units” herein and may be used interchangeably.

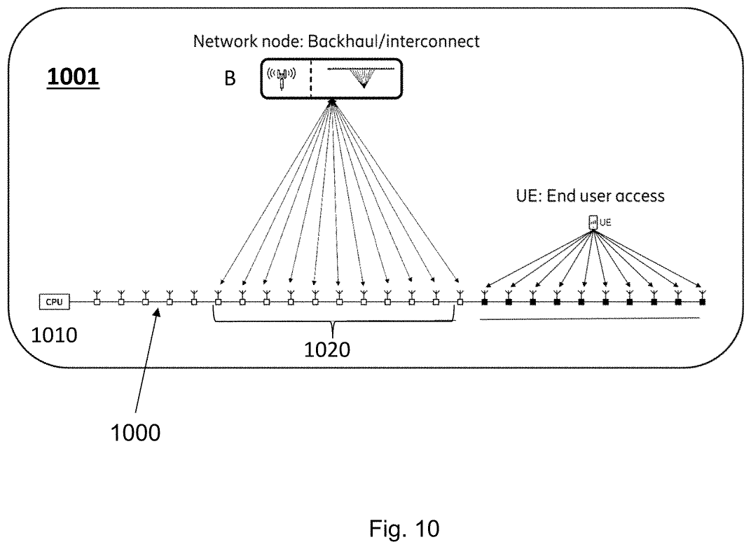

An example embodiment of an antenna unit 1000 according to embodiments herein is depicted in FIG. 10. A distributed MIMO system 1001 according to embodiments herein may comprise one or more antenna units 1000.

The antenna unit 1000 comprises at least one antenna element and at least one APU connected to the antenna element. The APU is configurable such that at least one APU in the antenna unit is assigned to service as over-the-air interconnects or backhaul based on load situation and processing power resource of the APU. The distributed MIMO system 1001 may comprise a CPU 1010 and the CPU 1010 may also have a backhaul connect using e.g. fiber. The APUs in the antenna unit 1000 may be connected to the CPU by at least one cable.

As shown in FIG. 10, the antenna unit 1000 uses unused antenna elements for backhaul or interconnect purposes, i.e. the APUs indicted with number 1020 are assigned to service as over-the-air interconnects towards a network node B. The network node B may e.g. be another antenna unit or radio stripe, antenna stripe, antenna stick, network stripe etc.

In some embodiments all transmissions to the network node B may be through the over-the-air backhaul or interconnect. In some embodiments only low-latency transmissions between the antenna unit 1000 and network node B are through the over-the-air connection.

Note that in some embodiments one APU controls a single antenna element while in other embodiments one APU controls multiple antenna elements. This implies that a fraction of processing power in an APU may be assigned for interconnects or backhaul. For example, one antenna element may be used for backhaul, and one antenna element may be used for end-user access. Observe that this may be that one antenna element is at 28 GHz and used for backhaul and one antenna element is at 4 GHz and used for end-user access. It may also be panels in different directions etc.

Embodiments herein will now be further explained and exemplified and may be combined with embodiments as described above and following in any suitable way.

### Example Embodiment

### Relay Connection Through Radio Stripe

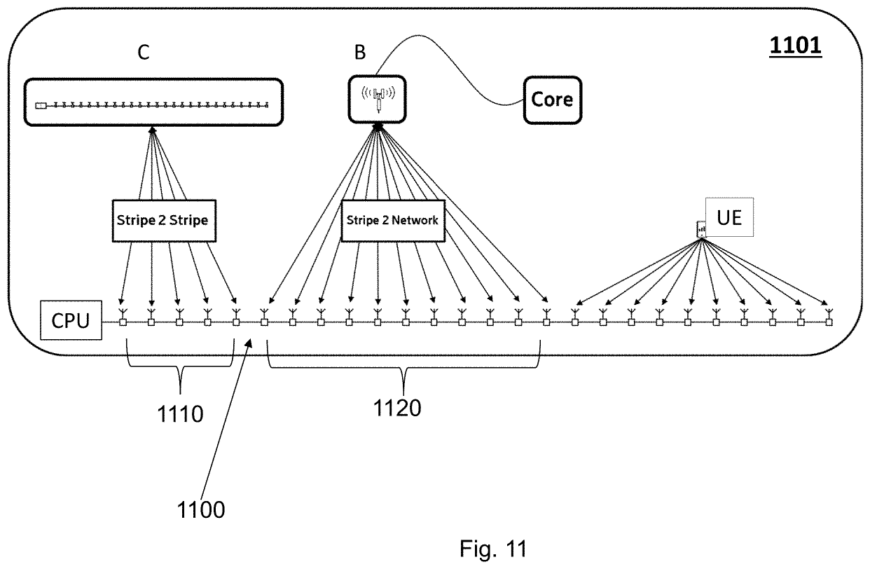

According to some embodiments, relay connection through a radio stripe is provided. That is a radio stripe functions as an intermediate step or relay between two other network nodes. Such a radio stipe 1100 comprised in a MIMO system 1101 is shown in FIG. 11. The APUs indicated by number 1110 may be assigned to service as interconnects to another radio stripe C, i.e. indicated by Stripe 2 Stripe connection. The APUs indicated by number 1120 may be assigned to service as interconnects to a network node B, indicated by Stripe 2 Network.

### Example Embodiment

### Multi-Stripe CoMP

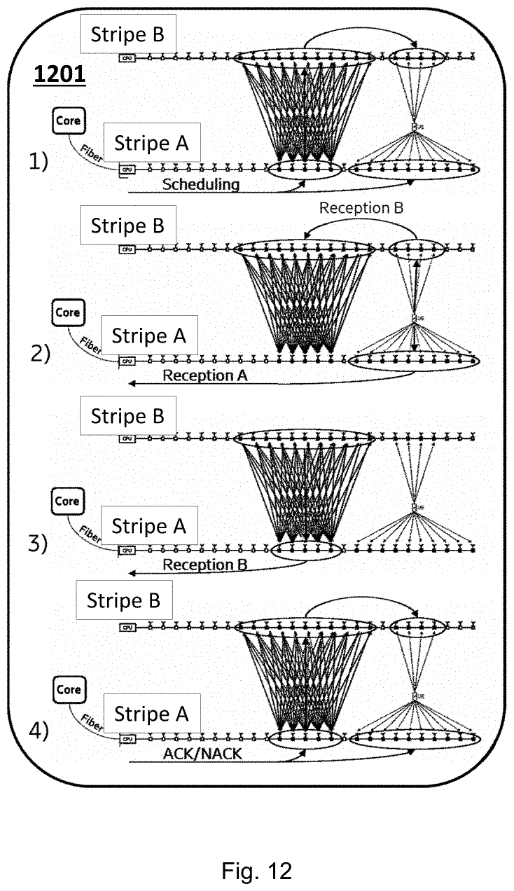

In some embodiments, the connection between two radio stripes is used to enable multi point reception or transmission, i.e. multi-stripe CoMP. Observe that the backhaul or interconnect between stripes is potentially very high capacity MIMO link due to that a massive MIMO array is available at both ends. FIG. 12 shows a MIMO system 1201 with a multi-stripe reception with stripe to stripe backhaul, to exemplify one embodiment of the steps for joint reception.

### Example Embodiment

### Load Sharing Between Radio Stripes and Network Coding

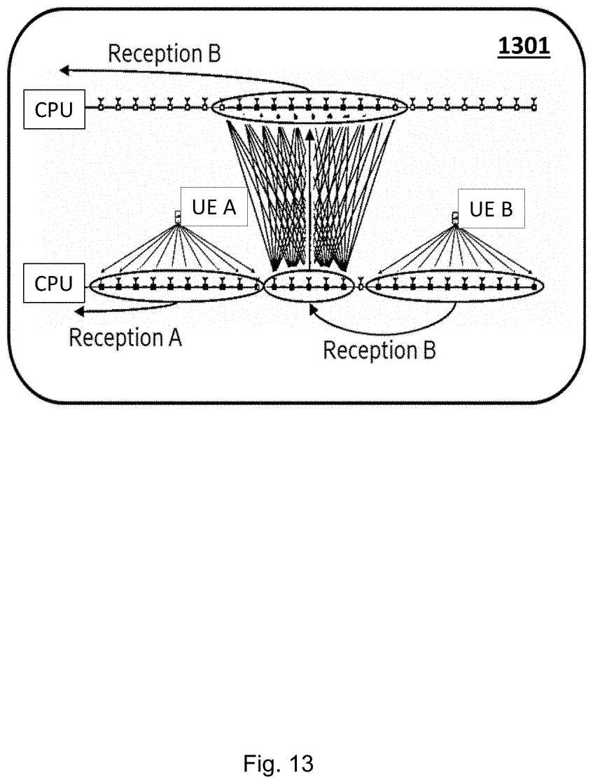

In some embodiments, load sharing between radio stripes and network coding is provided. That is, a routing decision may be made and thus distributing reception data between stripes, see FIG. 13, which shows a MIMO system 1301 with routing and load sharing using over-the-air communication between the radio stripes. This may be due to bottle-necks in the system, for example, in centralized e.g. in CPU, computational capability, in distributed e.g. APUs, computational capability, in power supply, or in backhaul capacity.

Especially if multiple wireless backhauls are used e.g. the reception data is relayed by more radio stripes, then separating the data may be used to lower interference in subsequent transmissions. The routing may also be used to distribute reception data so that all radio stripes cooperate in the transmission. For example, techniques such as a network coding may be used to optimize the multi-hop relaying. Network coding enables the network to “transform” interference between the transmissions into useful information and thus increasing the spectral efficiency of the system.

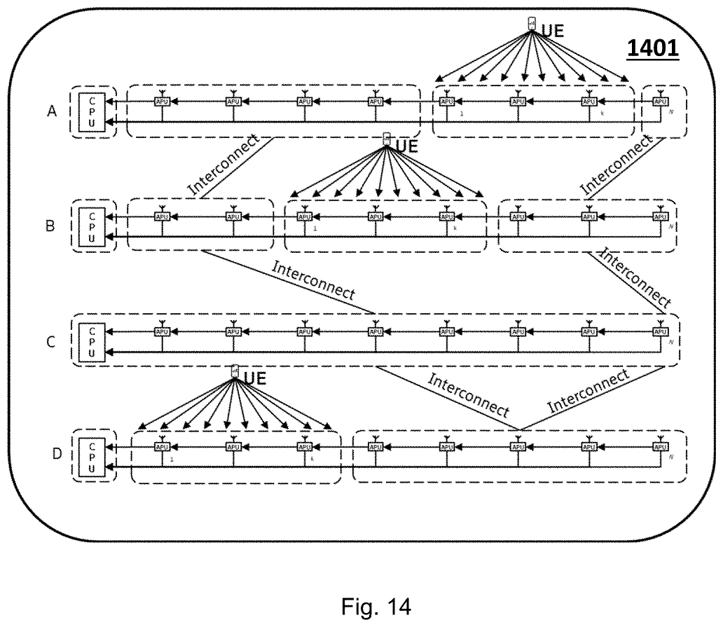

In general the routing of information and load sharing may be over a grid of radio-stripes deployed in a city, for example on the sides of the houses facing a square or similar. FIG. 14 shows such an example MIMO system 1401 with four radio stripes A, B, C, D in load-sharing configuration. The stripe C does not have any user service. This may be used either as support for the other stripes, or the stripe C may be taken down to sleep mode to save energy. This is understood by the system in terms of needed user services at a given time.

Hence, by using the interconnect between available antenna elements it may start sharing resources between different distributed serial MIMO systems. This means that it may get a grid of processing and memory capacity available to offer services requiring processing and memory.

Possible optimizations may be to introduce lowered individual element or unit performance. The setup where different stripes may connect makes it possible to reduce the need of individual processing capacity in each stripe. This benefits especially the CPU, which may be designed to handle fewer users if peaks can be off loaded to other stripes.

As shown in FIG. 14, the sharing or pooling of resources occurs at the outer edge of the network grid. However, further up in the network other pooled or shared resources are available.

### Example Embodiment

### Network Arrangement with Semi-Distributed Groups of Serially Connected Antenna Elements

In some embodiments, antenna elements are “semi-distributed” and installed in co-located groups. In a semi-distributed deployment, antenna elements and APUs may be installed in “antenna sticks” that are serially connected with a CPU. In such a configuration, some antenna elements may be utilized for serving user terminals directly while other antenna elements may be used for over-the-air interconnect functions towards other antenna sticks, stripes, or centralized antenna configurations.

### Example Embodiment

### Network Arrangement with “Backhaul Connected” and “Non-Backhaul Connected” Groups of Serially Connected Antenna Elements

In some arrangements implementing the invention presented here a network consists of two types of serially connected antenna installations, e.g. “radio stripes” or “radio sticks”, that are either “backhaul connected” or “non-backhaul connected”. A network may be upgraded by adding more non-backhaul connected “radio stripes” or “radio sticks” in an existing installation thereby creating improved connectivity from users to the nearest set of antenna elements as well as creating a larger amount of antenna elements that are available for over-the-air interconnect functions.

To summarize, embodiments herein provide a solution for over-the-air interconnect between a radio stripe and a network node by using unused APUs and antenna elements on said radio stripe. This enables more flexible and efficient deployment of radio stripes. This enables backhaul connection when this is not available, but also enables a very low latency and high capacity interconnect, especially between a stripe and a massive MIMO array/stripe.

Some embodiments herein also enable better CoMP operation for radio-stripes using very low latency over-the-air interconnect between different stripes or between stripes and other network nodes, especially when a good backhaul connection is not available.

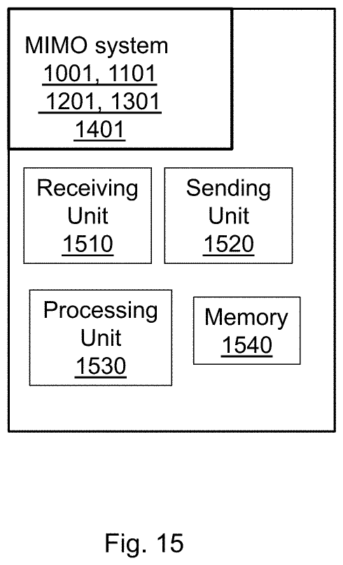

FIG. 15 shows an example of a base station 110 in the wireless communication network 100, wherein the MIMO system 1001, 1101, 1201, 1301, 1401 according to embodiments herein may be implemented. The base station 110 may further comprise a receiving unit 1510, a sending unit 1520, a processing unit 1530.

The base station 110 may further comprise memory 1540 comprising one or more memory units. The memory comprises instructions executable by the processing unit 1530 in the base station 110.

Some example Embodiments numbered 1-10 are described below.

### Embodiment 1

A distributed Multiple-Input Multiple-Output, MIMO, system comprising one or more antenna units, each antenna unit comprises at least one antenna element and at least one Antenna Processing Unit, APU, connected to the antenna element, wherein the APU in the one or more antenna units is configurable such that at least one APU in the one or more antenna units is assigned to service as over-the-air interconnects based on load situation and processing power resource of the APU.

### Embodiment 2

The distributed MIMO system according to Embodiment 1 further comprises a Central Processing Unit, CPU, and at least one APU is connected to the CPU by at least one cable.

### Embodiment 3

The distributed MIMO system according to any one of Embodiments 1-2, wherein the interconnects are used to transmit and receive data between the antenna units or to and from a network node.

### Embodiment 4

The distributed MIMO system according to any one of Embodiments 1-3, wherein the interconnects are used for synchronization between the antenna units or towards a network node.

### Embodiment 5

The distributed MIMO system according to any one of Embodiments 1-4, wherein the interconnects are used for Coordinated Multi-Point (CoMP) transmission and reception.

### Embodiment 6

The distributed MIMO system according to any one of Embodiments 1-5, wherein at least one APU not used for user access service is assigned to service as over-the-air interconnects.

### Embodiment 7

The distributed MIMO system according to any one of claims 1-6, wherein an antenna unit without backhaul connection is configured to connect to a network node or other antenna unit with backhaul connection by using the interconnects.

### Embodiment 8

The distributed MIMO system according to any one of Embodiments 1-7, wherein an antenna unit having less APU processing power resource is configured to connect to an antenna unit having more APU processing power resource by using the interconnects.

### Embodiment 9

The distributed MIMO system according to any one of Embodiments 1-8, wherein a fraction of the processing power resource is assigned for interconnect on an assigned APU and the remaining processing power resource is assigned for user access service.

### Embodiment 10

The distributed MIMO system according to any one of Embodiments 1-9, wherein assignment for user access service in at least one APU in the one or more antenna units is adjusted based on the interconnects assignment.

1. A distributed Multiple-Input Multiple-Output, MIMO, system comprising one or more antenna units, each antenna unit comprises at least one antenna element and at least one Antenna Processing Unit, APU, connected to the antenna element, wherein the APU in the one or more antenna units is configurable such that at least one APU in the one or more antenna units is assigned to service as over-the-air interconnects based on load situation and processing power resource of the APU.

2. The distributed MIMO system according to claim 1 further comprises at least one Central Processing Unit, CPU, and at least one APU is connected to the CPU by at least one cable.

3. The distributed MIMO system according to claim 1, wherein the interconnects are used to transmit and receive data between the antenna units or to and from a network node.

4. The distributed MIMO system according to claim 1, wherein the interconnects are used for synchronization between the antenna units or towards a network node.

5. The distributed MIMO system according to claim 1, wherein the interconnects are used for Coordinated Multi-Point, CoMP, transmission and reception.

6. The distributed MIMO system according to claim 1, wherein at least one APU not used for user access service is assigned to service as over-the-air interconnects.

7. The distributed MIMO system according to claim 1, wherein an antenna unit without backhaul connection is configured to connect to a network node or other antenna unit with backhaul connection by using the interconnects.

8. The distributed MIMO system according to claim 1, wherein an antenna unit having less APU processing power resource is configured to connect to an antenna unit having more APU processing power resource by using the interconnects.

9. The distributed MIMO system according to claim 1, wherein a fraction of the processing power resource is assigned for interconnect on an assigned APU and the remaining processing power resource is assigned for user access service.

10. The distributed MIMO system according to claim 1, wherein assignment for user access service in at least one APU in the one or more antenna units is adjusted based on the interconnects assignment.

11. A base station comprising a distributed MIMO system according to claim 1.

12. A wireless communication network comprising a plurality of base stations according to claim 11.
